(19) United States
(12) Patent Application Publication
(10) Pub. No.: US 2002/0184520 A1
(43) Pub. Date: Dec. 5, 2002

(54) Method and apparatus for a secure virtual machine

(76) Inventors: William R. Bush, San Mateo, CA (US); Anthony P.C. Ng, Singapore (SG); Douglas N. Simon, Mountain View, CA (US)

Correspondence Address: Finnegan, Henderson, Farabow,, Garrett & Dunner, L.L.P., 1300 I Street, N.W., Washington, DC, 20005-3315, US

(21) Appl. No.: 09/976,885

(22) Filed: Oct. 10, 2001

Related U.S. Application Data
(60) Provisional application No. 60/294,005, filed on May 30, 2001.

(51) Int. Cl. H04L 9/00

(52) U.S. Cl. 713/200

(57) ABSTRACT

A method is provided for providing security. The method involves separating classes into a trusted class and an untrusted class, associating privilege information with the trusted class, and controlling access to the trusted class by the untrusted class based upon the privilege information associated with the trusted class. The untrusted class may be granted a privilege used to control access to the trusted class. Granting the privilege may be based upon one or more permissive attributes of the privilege information. Based upon this privilege, access to the trusted class may be permitted or refused.

Applicants claim the right to priority based on Provisional Patent Application No. 60/294,005, filed May 30, 2001.

### TECHNICAL FIELD

This invention relates generally to computer security and, in particular, to the implementation of a secure virtual machine using a trusted category of software classes that uses associated privilege information to permit access and interaction with the trusted classes by other untrusted classes.

### DESCRIPTION OF RELATED ART

A cryptographic module, also referred to as a cryptographic token or a hardened token, is an example of a computing device or module which can store secrets, execute cryptograms and interact in well-defined ways with the external environment in a secure way. Those skilled in the art will quickly appreciate that a cryptographic module may be implemented as a type II PCMCIA module built around a cryptographic core of processing, memory and input/output units. An example of such a commercially available cryptographic module is the d'Cryptor PE cryptographic module developed by D'Crypt Pte. Ltd.

Additionally, those skilled in the art will appreciate that a cryptographic module typically operates by running a small and secure micro operating system and a virtual machine. Within the operating system and, optionally, a virtual machine, a correctly designed protocol can ensure the security of all transactions completed on the device.

Implementing such a protocol may be accomplished using platform independent software, such as the Java language developed by Sun Microsystems. Indeed, the Java 2 Platform, Micro Edition (J2ME™ technology) may be used to implement such a protocol and spans a broad array of customer and embedded electronics, such as a cryptographic module. Two basic J2ME™ configurations have been defined, one for devices that are typically mobile, and one for larger devices that typically are fixed. These configurations consist of core library sets and virtual machines optimized for the characteristics typically found in small devices.

Secure computing devices, such as cryptographic modules, are often physically sealed to resist tampering. Loading software securely onto such devices is therefore difficult, and is typically done at the factory before the devices are sealed. It is clearly desirable to be able to securely update the software on such devices once they are deployed.

When code is loaded, the set of permissions appropriate for the security of the computer system must be assigned to the code. If a set of permissions inappropriate for the security of the computer system is assigned to the code, the integrity and security of the computer system's resources may be compromised.

One existing method for adding security to new code, is separating the code into trusted and untrusted code. The separated code is executed using a conventional sandbox method of interpretation. The sandbox method allows all code to be executed, but only permits trusted code to have full access to a computer system's resources.

One drawback to the conventional sandbox approach is that all untrusted code is restricted to the same limited set of resources. Often, there is a need for flexibility when dealing with untrusted code. For example, there may be a need to permit untrusted code to have some defined access to the trusted computer resources, such as to particular data managed by the trusted code or to particular methods of the trusted code.

Based on the foregoing, it is clearly desirable to provide a virtual machine for separating code and assigning permissions on a level appropriate to the needed security of the computer system.

### SUMMARY OF THE INVENTION

In accordance with the present invention, security is provided by a small virtual machine. In accordance with one aspect of the present invention, as embodied and broadly described herein, a method involves separating classes into a trusted class and an untrusted class, associating privilege information with the trusted class, and controlling access to the trusted class by the untrusted class based upon the privilege information associated with the trusted class. The method may provide granting the untrusted class a privilege related to the trusted class based upon a permissive attribute of the privilege information, where the step of controlling access depends upon the privilege.

In accordance with another aspect of the present invention, as embodied and broadly described herein, a secure virtual machine instruction processor with a first memory space for storing an untrusted class, a second memory space for storing a trusted class, a privilege manager for managing privilege information associated with the trusted class, and a controller for controlling access to the trusted class during a trusted class operation, where the controller receives a request for a trusted class operation from the untrusted class and grants access to the trusted class based on at least one permissive attribute of the privilege information for the trusted class.

In accordance with yet another aspect of the present invention, as embodied and broadly described herein, a computer-readable medium on which is stored instructions, which when executed perform steps in a method for providing a secure virtual machine, the steps including, separating a plurality of classes into at least a trusted class and an untrusted class, associating privilege information with the trusted class and controlling access to the trusted class by the untrusted class based upon the privilege information associated with the trusted class.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the advantages and principles of the invention. In the drawings,

FIG. 1 shows an exemplary device in which embodiments of the present invention may be implemented;

FIG. 2A-D are exemplary diagrams that conceptually illustrate the grant of privilege consistent with an embodiment of the present invention;

FIG. 3 shows a block diagram of exemplary modules of an exemplary package consistent with an embodiment of the present invention.

FIG. 4 shows a block diagram of exemplary types of privilege information consistent with an embodiment of the present invention.

FIG. 5 shows a flow diagram of an exemplary process of allowing access to a trusted class consistent with an embodiment of the present invention.

### DETAILED DESCRIPTION

Reference will now be made in detail to an implementation of the present invention as illustrated in the accompanying drawings. Wherever possible, the same reference numbers will be used throughout the drawings and the following description to refer to the same or like parts.

An embodiment of the present invention may be implemented by a virtual machine on a small device. One embodiment of the invention separates classes into trusted classes and untrusted classes and associates privilege information, or permissions, with the trusted class. A trusted class is a class that is known to be secure. The trusted class includes process, objects, other classes, and threads. Privilege is an authorization by the trusted class that allows another class or object to perform a particular action or function. These functions can include, but are not limited too, creating a subclass of the trusted class, creating a new instance of the reusted class, allowing the untrusted class to invoke a method of the trusted class, and allowing the untrusted class assess to trusted data of teh trusted class. The architecture for and procedures to implement this invention, however, are not conventional, because they provide a mechanism for insuring the security of systems to overcome the shortcomings of the related art.

A. Exemplary System Architecture

Methods and apparatus consistent with the present invention are used to separate classes into trusted and untrusted classes. A class may include other classes, objects or any code-based element, to which the trusted class may grant a privilege. Although the following will be described with reference to particular embodiments, including data structures, flow of steps, hardware configurations, etc., it will be apparent to one skilled in the art that implementations of the present invention can be practiced without these specific details.

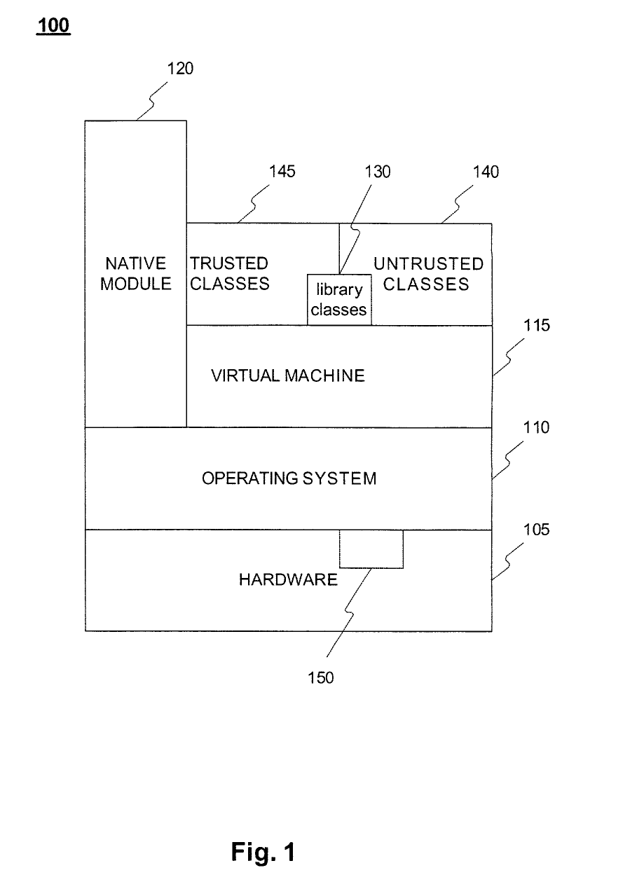

Implementations of the present invention use an exemplary system architecture, as illustrated in FIG. 1, where exemplary system 100 consists of hardware 105. Hardware 105 can be any type of computing hardware, such as a cryptographic module, or a cryptographic token. An example of such hardware is the d'Cryptor PE cryptographic token, developed by D'Crypt Pte Ltd. of Singapore. Another example is the IBM S/390 PCI Cryptographic Coprocessor, developed by IBM Corp. The cryptographic module should be able to store secrets, execute cryptograms, and interact in well-defined ways with the external environment, as well as being physically secure. Hardware 105 may include a real time clock and a noise sources, both of which can be used improve the security of the cryptographic module.

In the exemplary embodiment of FIG. 1, hardware 105 runs operating system 110. Operating system 110 can be any type of operating system capable of interacting with hardware 105. Examples include the Palm OS by Palm Computing and Windows CE by Microsoft Corp. Virtual machine 115 runs on top of operating system 110 as a main application module. Virtual machine 115 communicates with the operating system using secure native interfaces. Virtual machine 115 can be a modified Java virtual machine, performing byte-code interpretation and class loading. Examples of virtual machines include the Java virtual machine as defined by Sun Microsystems and the K virtual machine as defined by Sun Microsystems. The K virtual machine is a small virtual machine suitable for inexpensive mobile devices developed by Sun Microsystems. Those skilled in the art will be familiar with operating systems and virtual machines.

Library classes 130 reside on top of virtual machine 115. The J2ME Connected Limited Device Configuration developed by Sun Microsystems is an exemplary set of library classes for a virtual machine. Library classes 130 outline a basic set of library functionality that is available to all applications using virtual machine 115. Application code is separated into trusted classes and untrusted classes and sits above both virtual machine 115 and Library classes 130. The application code can be any code elements, such as an application to run on the device, new APIs, or alternate class libraries. Applications are divided or separated into trusted classes 145 and untrusted classes 140. This is typically a partitioning based on appropriate security levels. System 100 also includes native modules 120 for interacting with the physical inputs of the device and secures memory 150, which can be a protected memory location.

In creating a secure virtual machine, it has been found to be important to keep trusted classes and untrusted classes of applications clearly distinct and separated. Through rigorous separation of the classes, security can be insured. In one embodiment of the invention, the virtual machine becomes a secure virtual machine by implementing the separation of classes.

In the exemplary embodiment, the trusted classes and the untrusted classes are typically maintained in separate memory space. Users see a unified memory space, but internally two separate memory spaces are typically maintained. Trusted space is for those classes that come with trust certificates, while untrusted space is for untrusted classes that do not come with a trust certificate. A trust certificate is an authenticated verification of the trustworthiness of the source of information, which in this case are classes. Trust certificates are a common term known to one of skilled in the art. All calls between the spaces are monitored. Trusted classes can invoke method calls and access pubic instance data in untrusted classes. Untrusted classes are allowed to invoke accessible methods in trusted classes. A method is accessible if the trusted class has explicitly made it available to untrusted classes.

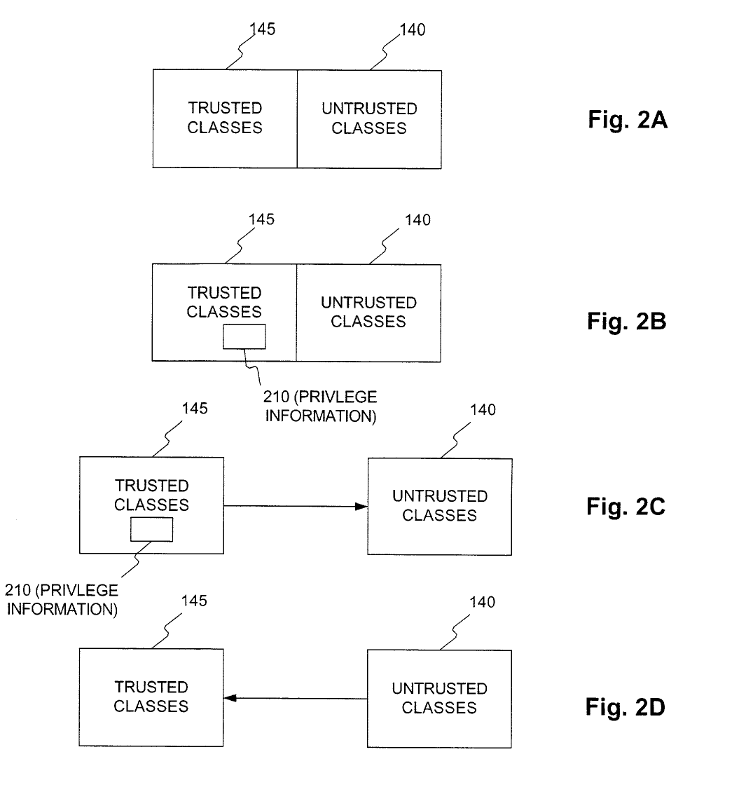

FIG. 2A illustrates the separation of classes into trusted classes 145 and untrusted classes 140 consistent with an embodiment of the present invention. Virtual machine 115 (FIG. 1) provides the means to express which parts of an application are trusted and to what degree parts are not. Trusted classes implement those parts of an application that have to be secured. They are also the means by which sensitive information is encapsulated.

FIG. 2B illustrates how an exemplary trusted class 145 contains privilege information 210 consistent with an embodiment of the present invention. Privilege information 210 contains a variety of permissive attributes, which can be considered to embody one or more privileges. In one embodiment of the present invention, privilege information can be stored in the form of a certificate. The certificate contains not only data that sets the privilege values for the classes, but also a public key of the owner of the class, a timestamp indicating creation time, flags or indicators of privilege, and other indicator of the security and trustworthiness of the class.

Permissive attributes allow for the granting or denying of access to the trusted class based on a set privilege level. This setting can be performed using a flag. The flag mechanism provides a means by which controlled exposure to untrusted classes can accomplished. The flag mechanism provides control over static methods in classes that cannot be instantiated. This is important since untrusted classes need access to some system calls. The flag mechanism is also a way of letting the user specify what is exposed in the sandbox. The sandbox method rigorously separates the execution of trusted and untrusted code. In a trusted space, only trusted classes are allowed to be executed. Access to the trusted sandbox space can be then granted in particular situations, such as when a flag is set to allow specific access.

FIG. 2C illustrates how trusted class 145 can grant one or more privileges to untrusted class 140 consistent with an embodiment of the present invention. The setting of a permissive attribute enables the trusted class to interact with the untrusted class in a predefined manner.

FIG. 2D illustrates how untrusted class 140 may receive access to trusted class 145 based on the granted privileges consistent with an embodiment of the present invention. When an untrusted class attempts to access a protected function in the trusted class, the privilege setting in the privilege information determines the scope of the interaction.

For example, if a class X needs a particular privilege from class Y, the owner of class X will have to acquire this privilege from the owner of class Y. These privileges may come in the form of a certificate authenticated by Y's owner and held by class X. They are verified by the virtual machine when class X is loaded. The difference between the trusted class and the untrusted class is that the trusted class will carry certificates with it that prove that it has certain privileges while the untrusted class has no such certificates.

The ability to subclass or instantiate a class does not imply the ability to subclass or instantiate any parent of the class in the class hierarchy independently. In the present embodiment, operations, such as subclassing or instantiation, on the parent of a class in question can only happen as a direct and automatic result of the same operation on the class itself. For example, if class X has permission to instantiate class B, which subclasses A, then it does not necessarily follow that X could directly instantiate A. To do so requires that X have explicit permission for instantiation from A. Consistent with an embodiment of the present invention, such permission is derived from privilege information associated with subclass A.

When loaded, classes are typically stored in packages in an embodiment of the present invention. Packages are separated into trusted and untrusted packages, in order to further insure the separation of the trusted and untrusted categories. Those skilled in the art will appreciate that Java typically employs the package construct to bundle groups of classfiles, not necessarily related in the class hierarchy, into a single name space. Packages provide a natural way of organizing and referring to classes and methods. Classes within a package have access rights to each other's protected fields and methods.

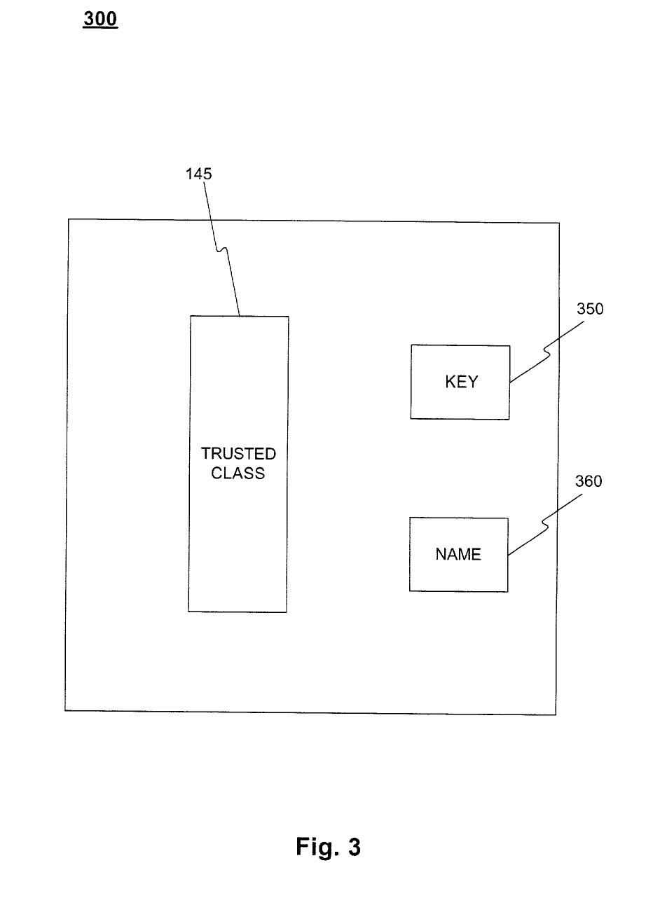

FIG. 3 illustrates an exemplary trusted package consistent with an embodiment of the present invention. In trusted package 300, trusted class 145 is stored. Also stored is key 350 to trusted package 300, and package name 360, which incorporates key 350. Key 350 may be a random bit string that is generated by an automatic process and that can be used to verify the security of the package. The key is part of the package name so that if anyone tries to put a class in a package without the right key, the class will be put in a different package. Typically, all trusted classes are stored in a trusted package. A trusted package may contain more then one trusted class. However, trusted packages only contain trusted classes, and never include untrusted classes.

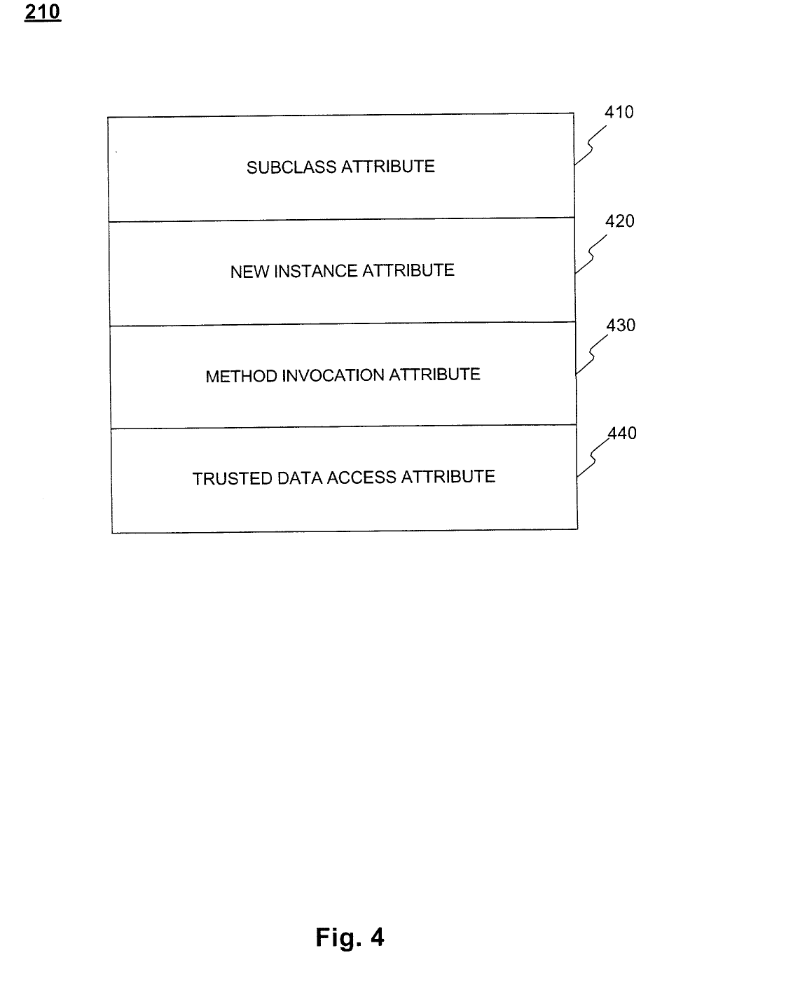

FIG. 4 illustrates exemplary privilege information 210 consistent with an embodiment of the present invention. Privilege information may be part of a certificate. Privilege information is a collection of data attached to each trusted class that determines its privileges. Privilege information 210 contains permissive attributes or privilege granting hierarchies for the various trusted class operations that an untrusted class may wish to access.

In more detail exemplary privilege information 210 contains permissive attributes 410-440. Permissive attribute 410 is a subclass attributes that indicates if an untrusted class has a privilege to subclass the trusted class. Permissive attribute 420 is a new instantiate attribute that indicates if an untrusted class has a privilege to create a new instance of the trusted class. Permissive attribute 430 is a method invocation attribute that indicates if an untrusted class has a privilege to invoke a method of the trusted class. Permissive attribute 440 is a trusted data access attribute indicates if an untrusted class has a privilege to access the trusted data of the trusted class.

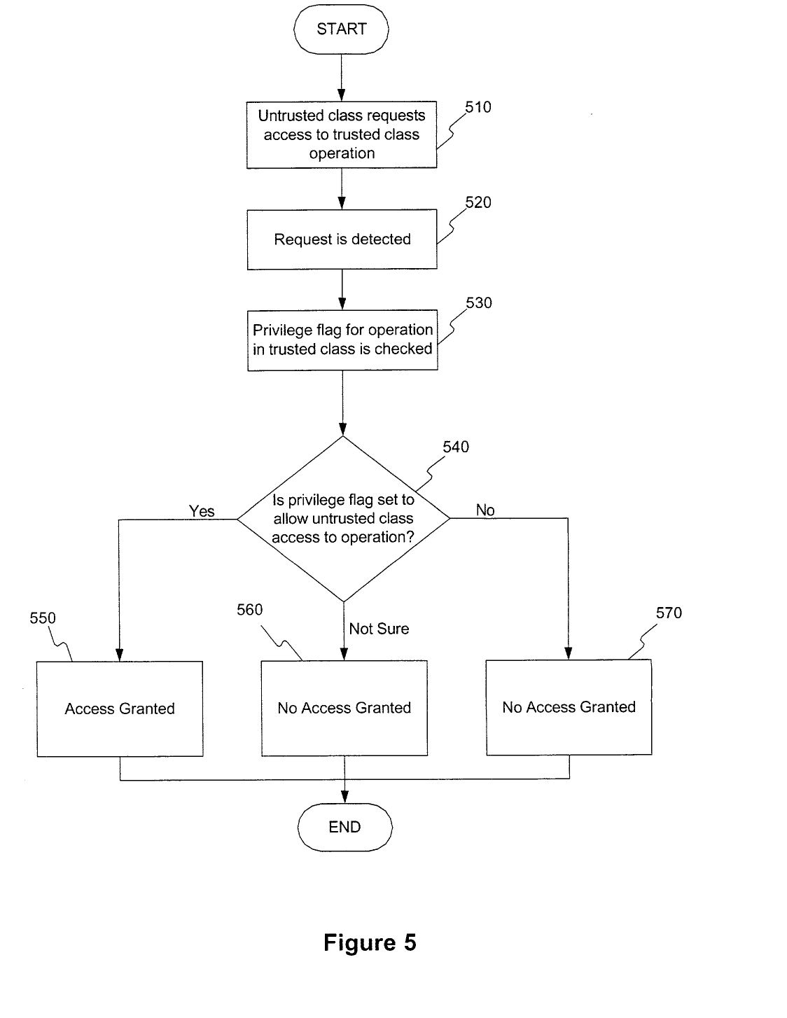

FIG. 5 is a flow diagram of an exemplary process by which access is granted to a trusted class consistent with an embodiment of the present invention. First, an untrusted class requests access to a trusted class operation (stage 510). The trusted class has privilege information, such as a trust certificate, associated with the class that is used to determine if the request is permissible. For example, a class may be installed on the platform, but it is when the class is loaded that verification of the subclassing trust certificate takes place. During the loading of a class, the privilege information associated with the class is verified. Thus, a class is known to be trusted only when it has loaded successfully and demonstrated that it has a valid trust certificate signed by the class that it subclasses.

A controller detects the request (stage 520). The controller serves as that part of the system which detects when requests are made by classes during operation of application code. An example of this is the Java Application Manager (JAM) within exemplary virtual machine 115. The controller checks the permissive attribute for the trusted class operation that is requested (stage 530). The controller determines if the permissive attribute is set to allow the untrusted class access to the operation (stage 540).

A privilege manager is the part of the exemplary virtual machine 115 within the system that manages the parameters that are set in the privilege information of permissive attributes, more generally called privilege information. The privilege manage determines if a trusted class has allowed access to any of its operations. If the privilege manager indicated that privilege was granted to the untrusted class, then access to the trusted class is granted (stage 540). If privilege was not granted to the untrusted class then no access is granted (stage 560). If the trusted class cannot determine if privilege was given, then typically no access is granted (stage 550). Thus, all privileges are typically denied except those explicitly granted.

Those skilled in the art understand that the present invention can be implemented in a wide variety of platforms. Accordingly, the invention is not limited to the above described implementations, but instead is defined by the appended claims in light of their full scope of equivalents.

What is claimed is:

1. A method for providing security, comprising:
separating a plurality of classes into at least a first trusted class and an untrusted class;
associating privilege information with the first trusted class; and
controlling access to the first trusted class by the untrusted class or a second trusted class based upon the privilege information associated with the first trusted class.

2. The method of claim 1 further comprising:
granting the untrusted class or the second trusted class a privilege related to the first trusted class based upon a permissive attribute of the privilege information; and
wherein the step of controlling access depends upon the privilege.

3. The method of claim 1 further comprising:
refusing to grant the untrusted class or second trusted class a privilege related to the first trusted class based upon a permissive attribute of the privilege information; and
wherein controlling access depends upon the privilege.

4. The method of claim 2, wherein controlling access further comprises:
determining if the privilege allows the untrusted class or second trusted class to interact with the first trusted class in a predefined manner; and
permitting the access to the first trusted class in the predefined manner if the privilege permits the access.

5. The method of claim 4 further comprising denying the access to the first trusted class in the predefined manner if the access to the first trusted class in the predefined manner is contrary to the privilege.

6. The method of claim 5, wherein the privilege allows at least one of the group of creating a subclass of the first trusted class, creating a new instance of the first trusted class, allowing the untrusted class or second trusted class to invoke a method of the first trusted class, and allowing the untrusted class or second trusted class access to trusted data of the first trusted class.

7. The method of claim 1, wherein the step of separating the classes further comprises associating a package with the first trusted class.

8. The method of claim 7, wherein associating the package further a comprises encapsulating the first trusted class within the package.

9. The method of claim 7, wherein the package further comprises:
a key;
a package name incorporating the key;
the privilege information; and
the first trusted class.

10. The method of claim 1, wherein the step of separating the classes further comprises allocating a separate memory space for the first trusted class and the untrusted class.

11. The method of claim 1, wherein the privilege information further comprises a plurality of permissive attributes.

12. The method of claim 11, wherein the permissive attributes comprises at least one of the group of a subclass attribute, a new instance attribute, a method invocation attribute, and a trusted data access attribute.

13. A method of claim 11 further comprising setting the permissive attribute to indicate a privilege grant to the untrusted class or second trusted class.

14. The method of claim 11, wherein a default for the permissive attribute indicates no privilege grant to the untrusted class or second trusted class.

15. The method of claim 1, wherein controlling access to the first trusted class further comprises:
detecting when a request for a trusted class operation is made by the untrusted class or second trusted class;
determining that the trusted class operation is authorized based on the privilege information associated with the first trusted class; and
allowing access to the first trusted class according to the trusted class operation.

16. The method of claim 15, wherein the trusted class operation is at least one of a group of operations comprising a subclass operation, a new instance creation, a method call operation, and a trusted data access operation.

17. A method of claim 15, wherein the step of determining further comprises determining that the trusted class operation is authorized based on the setting for at least one permissive attribute within the privilege information.

18. A secure virtual machine instruction processor comprising:
a first memory space for storing an untrusted class;
a second memory space for storing a first trusted class;
a privilege manager for managing privilege information associated with the first trusted class; and
a controller for controlling access to the first trusted class during a trusted class operation, wherein the controller is operative to receive a request for the trusted class operation from the untrusted class or a second trusted class and grant access to the first trusted class based on at least one permissive attribute within the privilege information for the first trusted class.

19. A processor of claim 18, wherein the request received by the controller is one of the group of a subclass attribute, a new instance attribute, a method invocation attribute, and a trusted data access attribute.

20. A processor of claim 18, wherein the controller is further operative to permit access to the first trusted class in a predefined manner if the privilege permits the access.

21. A processor of claim 18, wherein the controller is further operative to deny access to the first trusted class in a predefined manner if the privilege is contrary to the privilege.

22. A processor of claim 18, wherein the first trusted class of the second memory space is associated with a package.

23. A processor of claim 22, wherein associating the package further comprises encapsulating the first class within the package.

24. A processor of claim 22, wherein the package further comprises:
a key;
a package name incorporating the key;
the privilege information; and
the first trusted class.

25. A computer-readable medium on which is stored instructions, which when executed perform steps in a method for providing a secure virtual machine, the steps comprising:
separating a plurality of classes into at least a first trusted class and an untrusted class;
associating privilege information with the first trusted class; and
controlling access to the first trusted class by the untrusted class or a second trusted class based upon the privilege information associated with the first trusted class.

26. The computer-readable medium of claim 25 further comprising:
refusing to grant the untrusted class or second trusted class a privilege related to the first trusted class based upon a permissive attribute of the privilege information; and
wherein the step of controlling access depends upon the privilege.

27. The computer-readable medium of claim 25 further comprising:
granting the untrusted class or second trusted class a privilege related to the first trusted class based upon a permissive attribute of the privilege information; and
wherein the step of controlling access depends upon the privilege.

28. The computer-readable medium of claim 25 further comprising denying the access to the first trusted class in the predefined manner if the access to the first trusted class in the predefined manner is contrary to the privilege information.

29. The computer-readable medium of claim 28 wherein the privilege information allows at least one of the group of creating a subclass of the first trusted class, creating a new instance of the first trusted class, allowing the untrusted class or second trusted class to invoke a method of the first trusted class, and allowing the untrusted class or second trusted class access to trusted data of the first trusted class.
